(19) United States
(12) Patent Application Publication
(10) Pub. No.: US 2006/0243893 A1
(43) Pub. Date: Nov. 2, 2006

(54) A LIGHT SOURCE FOR LCD BACK-LIT DISPLAYS UTILIZING EMBEDDED LIGHT DETECTORS

(76) Inventors: Fook Chuin Ng, Penang (MY); Tak Meng Cheang, Penang (MY); Choon Guan Ko, Penang (MY); Choon Keat Chew, Perak (MY)

Correspondence Address: AVAGO TECHNOLOGIES, LTD., P.O. BOX 1920, DENVER, CO, 80201-1920, US

(21) Appl. No.: 11/119,206

(22) Filed: Apr. 28, 2005

(51) Int. Cl. G01J 1/04

(52) U.S. Cl. 250/227.11

(57) ABSTRACT

A light source having a photodetector embedded in a light pipe is disclosed. The light pipe includes a layer of transparent material having top and bottom surfaces and first and second opposing side surfaces that intersect the top and bottom surfaces. In one embodiment, the photodetector is embedded in the layer at a location that is adjacent to the second side surface and a plurality of light emitters are positioned so as to couple light into the layer of material through the first side edge at angles less than or equal to the critical angle for the layer of material. The bottom surface can include protrusions for scattering light toward the top surface. A controller adjusts the intensity of the various light emitters in response to changes in light intensity detected by the photodetector. Light leaving the top surface of the light pipe can be used to illuminate a display.

### BACKGROUND OF THE INVENTION

Liquid crystal displays (LCDs) are used in a wide variety of computers and consumer devices such as TVs. A back-lit LCD is an array of pixels in which each pixel acts as a shutter that either passes or blocks light from a light source that is located behind the pixel. Color displays are implemented by equipping the pixels with color filters such that each pixel transmits or blocks light of a particular color. The intensity of the light from each pixel is set by the time the pixel is in the transmissive state.

The display is typically illuminated by a white light source that provides a uniform intensity of light across the back surface of the display. Illumination sources based on fluorescent lights are particularly attractive because of their high light output per watt-hour of power consumed. However, such sources require high driving voltages which makes them less attractive for battery operated devices.

As a result, there has been considerable interest in utilizing light sources based on LEDs in such applications. LEDs have similar electrical efficiency and long lifetimes. In addition, the driving voltages needed are compatible with the battery power available on most portable devices. An LED light source for generating an arbitrary color of light is typically constructed from three LEDs. The relative intensities of the LEDs are adjusted by adjusting the drive current through the LED and/or the duty factor of the LED. In the latter arrangement, the LEDs are turned on and off within a cycle time that is too short to be perceived by a human observer. The intensity of the light seen by the viewer is the average intensity, and hence, the relative intensities of the various colors is determined by the percentage of the time the various LEDs are turned on.

Unfortunately, LEDs suffer from aging problems. As the LED ages, the drive current through the LED or the duty factor for the LED must be increased to compensate for the aging of the LED. Since the aging effects are different for different color LEDs, the perceived color of the display will shift with age unless the drive currents are altered or duty factors are altered. In one class of light sources, the intensity of light in each of the color bands is measured by a corresponding set of photodiodes. The drive conditions are then adjusted to maintain the output of the photodiodes at a set of predetermined values corresponding to the desired perceived color for the light source. This approach requires a design in which the photodiodes sample the light that is generated by the LEDs.

Back-lit illumination systems for LCD arrays typically utilize some form of light box or light pipe behind the LCD array. Light is injected into this light box at the periphery of the light box. The surface of the light box opposite to the surface that is adjacent to the LCD array has some form of scattering covering that scatters the light so that the back surface of the LCD is uniformly illuminated. To provide the feedback loop for compensating for the aging effects discussed above, the photodiodes are typically located outside of the light pipe along one of the edges of the light pipe. The amount of light that eventually enters the photodiodes in this arrangement is small and subject to variations from source to source. In addition, the structure on which the photodiodes are mounted increases the cost of the light source. Finally, care must be taken to eliminate ambient light from reaching the photodiodes. Such precautions further increase the cost of the resulting light source.

The thickness of the light source is limited by the thickness of the light box. The thickness of the display is particularly important in displays used for laptop computers and handheld devices such as photodetector arrays and cellular telephones, as the display thickness limits the overall thickness of the device. Some of these portable devices require light boxes that are less than 10 mm thick. As the thickness of the light box is reduced, the problems discussed above become more acute.

### SUMMARY OF THE INVENTION

That present invention includes a light source having a photodetector embedded in a light pipe. The light pipe includes a layer of material having top and bottom surfaces, the material being transparent to light in a transmission band of wavelengths. The layer has first and second opposing side surfaces that intersect the top and bottom surfaces. In one embodiment, the photodetector is embedded in the layer at a location that is adjacent to the second surface. In one embodiment, the light source includes a plurality of light emitters that emit light in the transmission band. The light emitters are positioned so as to couple light into the layer of material through the first edge. In one embodiment, the light emitters are LEDs. In one embodiment, the light emitters couple the light into the layer at angles less than or equal to the critical angle for the layer of material. In one embodiment, the bottom surface includes protrusions for scattering light toward the top surface. In one embodiment, the light emitters include emitters that emit light in a plurality of wavelength bands. In one embodiment, the light generated by the light emitters is perceived to be white light by a human observer. In one embodiment, the photodetector includes a plurality of band detectors, each band detector detecting light in a band of wavelengths specific to that band detector. In one embodiment, the photodetector includes a plurality of emitter detectors, each emitter detector detecting light from a corresponding one of the light emitters.

### BRIEF DESCRIPTION OF THE DRAWINGS

FIG. 1 is a top view of light source 10.

FIG. 2 is a cross-sectional view of light source 10 through line 2-2 shown in FIG. 1.

FIG. 3 is a cross-sectional view of a light source according to one embodiment of the present invention positioned to illuminate a LCD display.

FIG. 4 is a cross-sectional view of a photodetector array 60 that is suitable for use in the present invention.

FIG. 5 is a top view of a light source according to one embodiment of the present invention.

FIG. 6 is a top view of a light source 100 according to another embodiment of the present invention.

### DETAILED DESCRIPTION OF THE PREFERRED EMBODIMENTS OF THE INVENTION

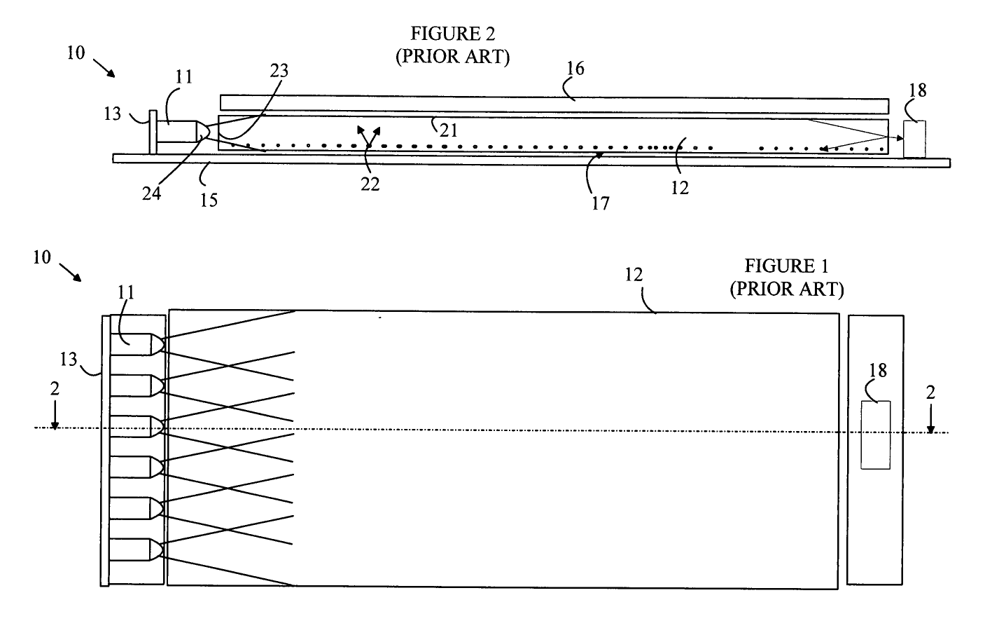

The manner in which the present invention provides its advantages can be more easily understood with reference to FIGS. 1 and 2, which illustrate a prior art light box arrangement for illuminating an LCD display 16. FIG. 1 is a top view of light source 10 and FIG. 2 is a cross-sectional view of light source 10 through line 2-2 shown in FIG. 1. Light source 10 utilizes an array of LEDs 11 to illuminate a light pipe 12. The LEDs are mounted on a circuit board 13 that is mounted on a second board 15 that provides power to the LEDs. The LEDs are positioned such that light leaving the top of each LED via lens 24 illuminates the end 23 of light pipe 12. The light entering light pipe 12 at an angle less than the critical angle with respect to surface 21 is reflected back and forth within light pipe 12 until the light is either absorbed or scattered by particles 22 on surface 17. The scattered light that strikes surface 21 at angles greater than the critical angle escapes from the light pipe and illuminates the back surface of LCD display 16.

The spectral content of the light in the light pipe is sampled by an array of photodiodes shown at 18. Each photodiode in the array includes a wavelength filter that limits the light reaching that photodiode to light in the predetermined band of wavelengths. As noted above, the output from the photodiodes is used by a feedback controller to regulate the currents or duty cycles of the LEDs.

The amount of light that leaves the light pipe and reaches the photodiodes depends on a number of factors that are difficult to control. Only light striking the end of the light pipe at angles greater than the critical angle exits the light pipe. However, even a portion of that light will be reflected back into the light pipe due to the difference in index of refraction between the light pipe and the air between the end of the light pipe and the photodiode array. Furthermore, once the light exits the end of the light pipe, the rays will diverge. Hence, without an optical system to collect the light, the amount of light that actually arrives on the active area of the photodiodes is only a small fraction of the light leaving the end of the light pipe. If a collection system is used to increase the light, the distance between the end of the light pipe and the photodiode array must be increased. This increased distance increases the size of the light source, which presents problems in small handheld devices such as cell phones.

In addition, the amount of light reaching the photodiodes will depend on the alignment of the optical system with respect to the end of the light pipe and on the detailed surface topology of the end of the light pipe. Imperfections in the light pipe end or soil on the surface will alter the light collection efficiency. Furthermore, most of the light reaching the detector will have been reflected numerous times from the top and bottom surfaces of the light pipe. If any of these surfaces has a reflection coefficient that varies with wavelength, the photodetectors will have different collection efficiencies as a function of wavelength.

Furthermore, the alignment of the photodetectors with respect to the light pipe depends on the precision with which the light pipe and photodetectors are mounted on printed circuit board 15. If the photodetectors are attached via pins or surface mounts that are soldered onto or into the printed circuit board, there will be variations in the relative position of the light pipe and photodetectors. In addition, if the printed circuit board is used to dissipate the heat generated by the LEDs, the board will flex due to the changes in temperature as the board heats up. Such flexing can further alter the position of the photodetectors with respect to the light pipe.

While such collection efficiency factors can be removed with adequate calibration of the feedback loop, the calibration procedure itself increases the cost of the device, and hence, is preferably avoided. However, problems associated with temperature fluctuations causing flexing in the printed circuit board cannot be easily corrected by calibration, since the calibration factors change with temperature. Furthermore, all of the above problems become more acute as the thickness of the light pipe is reduced.

The present invention overcomes these problems by incorporating the color sensor in the light pipe itself. This guarantees that the color sensor will always be properly aligned with the light pipe. In addition, problems associated with light losses due to the difference in the index of refraction between the light pipe and the air between the color sensor and the light pipe are substantially reduced, since the only change in index of refraction is between the sensor material and the light pipe.

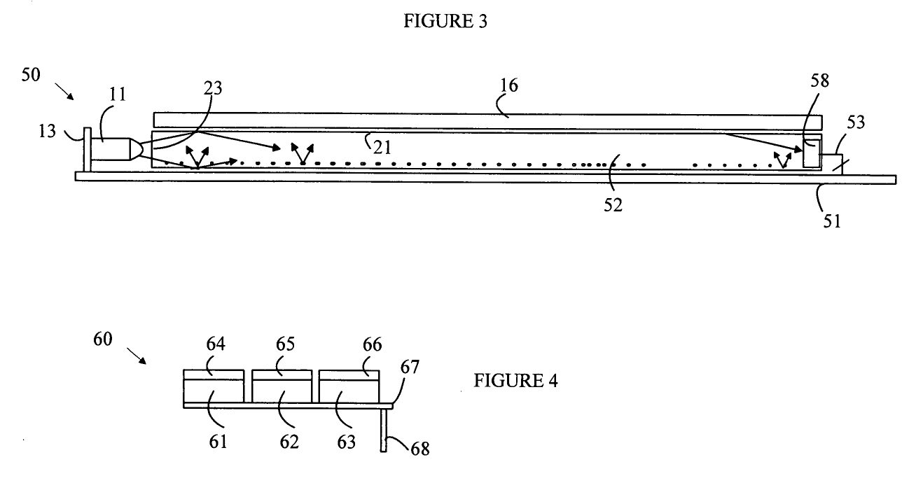

Refer now to FIG. 3, which is a cross-sectional view of a light source according to one embodiment of the present invention positioned to illuminate a LCD display 16. To simplify the following discussion, those elements of light source 50 that serve functions analogous to elements discussed above with reference to FIGS. 1 and 2 have been given the same numerical references as used in FIGS. 1 and 2 and will not be discussed further here. Light source 50 utilizes a photodetector array 58 that is molded into a plastic light pipe 52 to provide the feedback signals needed to control the currents in the LEDs 11. The leads 53 from photodetector array 58 protrude through the edge of light pipe 52 and are connected to a printed circuit board 51. In this embodiment, printed circuit board 51 is also used to mount the LED array.

It should be noted that any flexure of the printed circuit board relative to light pipe 52 is accommodated by the leads 53. Hence, changes in temperature that cause the circuit board to warp away from the light pipe do not change the light collection efficiency of the color sensors. The leads also accommodate any variations in height associated with attaching the sensors to printed circuit board 51. In addition, the leads provide a means for affixing) one end of the light pipe to the circuit board, and hence, reduce the fabrications costs associated with the attachment of the light pipe to the printed circuit board.

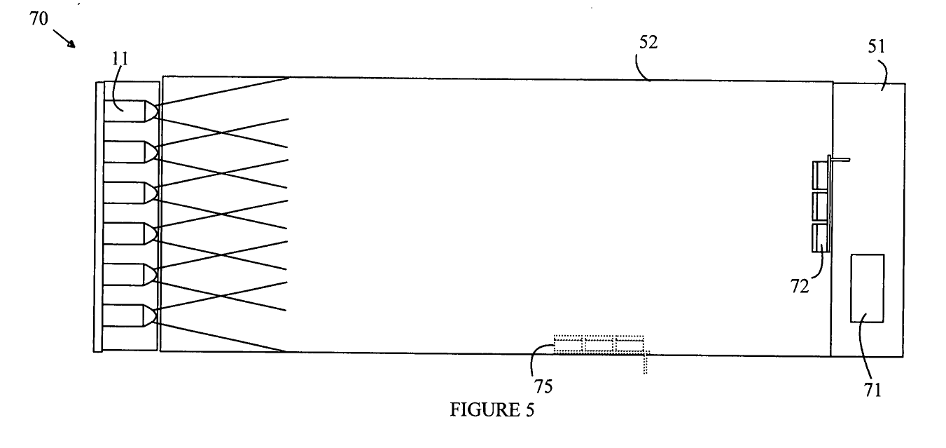

Refer now to FIG. 4, which is a cross-sectional view of a photodetector array 60 that is suitable for use in the present invention. Photodetector array 60 is constructed from three photodetectors that utilize the photodiodes shown at 61-63 connected to a lead frame 67 that includes the leads 68 that provide the output signals from the photodiodes. To simplify the drawing, the various connections between photodiodes 61-63 and lead frame 67 have been omitted from the drawing.

In one embodiment, the three photodiodes are identical to one another and are sensitive to light over the visible spectrum. The wavelength specificity of the photodetectors is provided by three optical band pass filters 64-66. Such filters are known to the art, and hence, will not be discussed in detail here. For the purposes of this discussion it is sufficient to note that the filters can be constructed by depositing appropriate materials on the photodiodes and that these materials can withstand the temperatures normally encountered in plastic molding processes.

Refer now to FIG. 5, which is a top view of a light source according to one embodiment of the present invention. Light source 70 utilizes a photodetector array 72 that is similar to photodetector array 60 discussed above. Photodetector array 72 is molded into light pipe 52 along the end opposite to LEDs 11. In this embodiment, the photodetector array samples the light after the light has been mixed in the light pipe and provides signals indicative of the total intensities of light in each of three wavebands. If there is more than one LED that emits light in a given waveband, it is assumed that all of the LEDs are driven by the same signal. An onboard controller 71 provides the drive signals in this embodiment.

In embodiments in which the photodetector array samples the mixed light and there is more than one LED that emits light in each band, the photodetector array is preferably positioned such that the light received is primarily scattered or reflected light, as opposed to light that travels directly from the LEDs to the photodetector array. If the photodetector array is a long distance from the LEDs in comparison to the thickness of the light pipe, this will be the case, since the solid angle subtended by the photodiode array at the LEDs will be small, and hence, very little direct light will be measured. However, if the direct light is a problem, the photodiode array can be mounted on the side of light pipe 52 as shown in phantom at 75.

In some cases, it may be useful to monitor the individual LEDs as opposed to the mixed light signal. For example, in systems in which there are multiple LEDs for each color, monitoring the mixed light signal only provides information about the overall color spectrum. If an LED of one color is aging faster than the other LEDs of that color, merely increasing the drive current to all of the red LEDs based on the reduction in light of that color can lead to local color variations. This problem can be avoided by monitoring the individual LEDs rather than the mixed light signal.

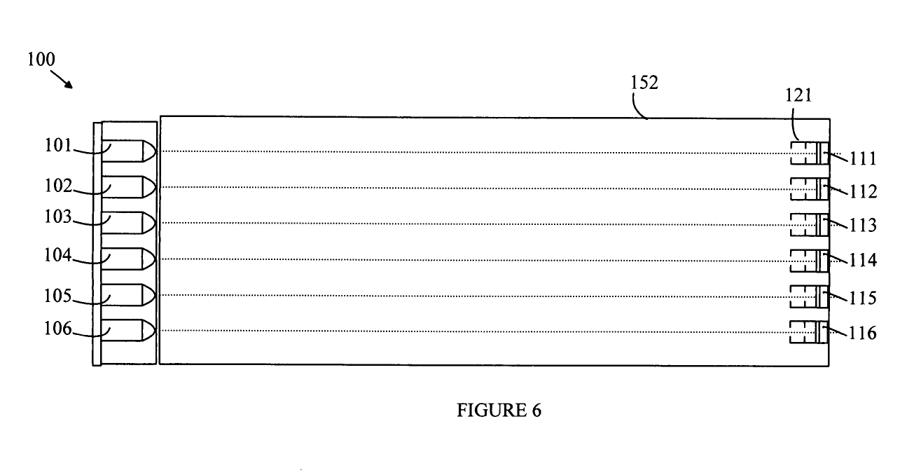

Refer now to FIG. 6, which is a top view of a light source 100 according to another embodiment of the present invention. Light source 100 includes 6 LEDs shown at 101-106. There are two LEDs corresponding to each color band. The LEDs are preferably arranged such that adjacent LEDs generate different colors of light. For example, LEDs 101 and 104 generate green light, LEDs 102 and 105 generate red light, and LEDs 103 and 106 generate blue light. Each LED is monitored by a corresponding photodiode. The photodiodes corresponding to LEDs 101-106 are shown at 111-116, respectively. Each photodiode includes a collimator 121 that prevents light from the other LEDs or light that is reflected from the surfaces of light pipe 152 from entering the photodiode. Hence, only light that travels directly from an LED to its corresponding photodiode is detected by the photodiode. In the embodiment shown in FIG. 6, each of the photodiodes includes a wavelength filter that limits the spectral range of the light detected by that photodiode. However, if the collimation is sufficient to eliminate light from adjacent LEDs, these filters can be omitted.

Various modifications to the present invention will become apparent to those skilled in the art from the foregoing description and accompanying drawings. Accordingly, the present invention is to be limited solely by the scope of the following claims.

1. A light source comprising:
a light pipe comprising a layer of material having top and bottom surfaces, said material being transparent to light in a transmission band of wavelengths, said layer having first and second opposing side surfaces that intersect said top and bottom surfaces; and
a photodetector for measuring an intensity value for light traveling in said light pipe, said photodetector being embedded in said layer of material and generating a signal indicative of said measured intensity value for said light, said photodetector having a surface through which light that is measured by said photodetector passes, said surface being connected to said layer of material by a material having an index of refraction greater than that of air.

2. A light source comprising:
a light pipe comprising a layer of material having top and bottom surfaces, said material being transparent to light in a transmission band of wavelengths, said layer having first and second opposing side surfaces that intersect said top and bottom surfaces;
a photodetector for measuring light traveling in said light pipe, said photodetector being embedded in said layer of material and generating a signal indicative of said measured light; and
a plurality of light emitters that emit light in said transmission band, said light emitters being positioned so as to couple light into said layer of material through said first side surface.

3. The light source of claim 2 wherein said photodetector is adjacent to said second side surface.

4. The light source of claim 2 wherein said light emitters comprise light-emitting diodes (LEDs).

5. The light source of claim 2 wherein said light emitters couple said light into said layer at angles less than or equal to the critical angle for said layer of material.

6. The light source of claim 2 wherein said bottom surface comprises protrusions for scattering light toward said top surface.

7. The light source of claim 2 wherein said light emitters comprise a first emitter that emits light in a first band of wavelengths within said transmission band and a second emitter that emits light in a second band of wavelengths within said transmission band, said first band being different from said second band.

8. The light source of claim 2 wherein said light emitters emit light that is perceived to be white light by a human observer.

9. The light source of claim 7 wherein said photodetector comprises a plurality of band detectors, each band detector detecting light in a band of wavelengths specific to that band detector.

10. The light source of claim 9 wherein each of said band detectors comprises a photodiode and a band pass filter.

11. The light source of claim 7 wherein said photodetector comprises a plurality of emitter detectors, each emitter detector detecting light from a corresponding one of said light emitters.

12. The light source of claim 2 further comprising a controller for regulating the light emitted by said light emitters in response to signals generated by said photodetector.
